(19) United States
(12) Patent Application Publication
(10) Pub. No.: US 2021/0204533 A1
(43) Pub. Date: Jul. 8, 2021

(54) SPOOL LINE RELEASE SYSTEM AND METHOD OF USE

(71) Applicant: Jeremiah Law Hayes, Arlington, TX (US)

(72) Inventor: Jeremiah Law Hayes, Arlington, TX (US)

(21) Appl. No.: 16/737,843

(22) Filed: Jan. 8, 2020

(51) Int. Cl. A01K 89/015

(52) U.S. Cl. CPC A01K 89/0192; A01K 89/01931

(57) ABSTRACT

A cap for securing to a reel, the cap includes a body extending from a first end to a second end; an opening at the second end of the body and to have fishing line extending therethrough; and an attachment device to provide for securing of the body to the reel; the cap extends away from the reel to prevent friction, drag and inefficiencies from affecting the line.

### BACKGROUND

### Field of the Invention

The present invention relates a spool line release system and method of use.

Spool line release systems are well known in the art and are commonly used in fishing, including bow fishing. In FIG. 1, a conventional spool line release system is shown, having a reel 103 with a cap 105 secured thereon. During use, the line will be housed in the reel 103 and exit through the cap 105. These conventional systems have several drawbacks, such as having drag associated with the line, tangling, and other drawbacks.

Accordingly, although great strides have been made in the area of spool line release systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a conventional spool line release system;

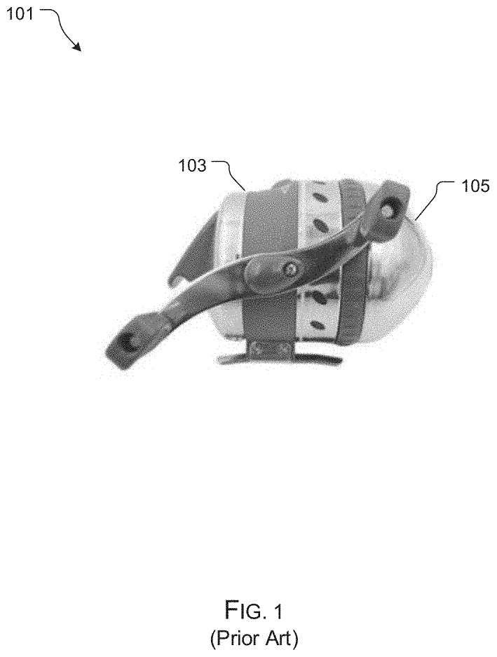

FIG. 2 is an isometric view of a cap for spool line release system in accordance with the present application;

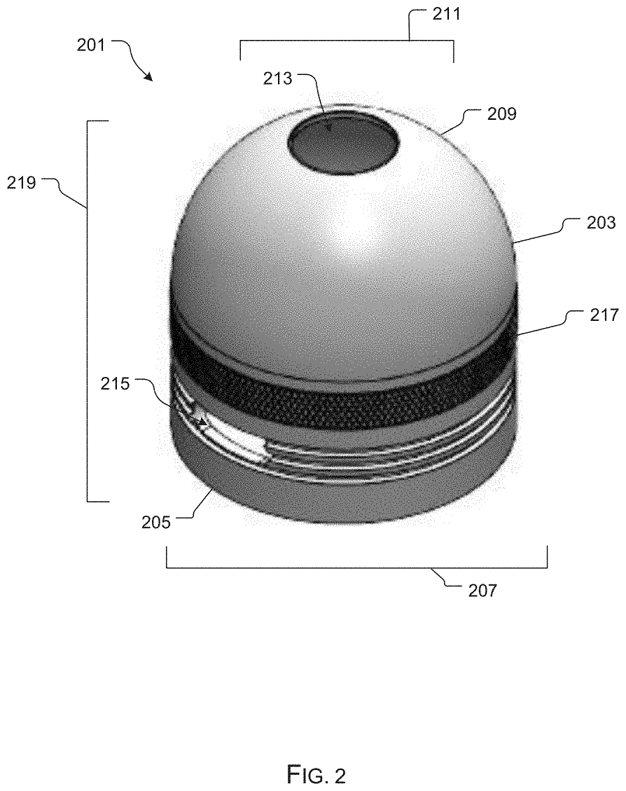

FIG. 3 is a side view of a spool line release system in accordance with the present application;

FIG. 4 is a cross sectional view of the cap of FIG. 2; and

FIG. 5 is a flowchart of the method of use of the system of FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

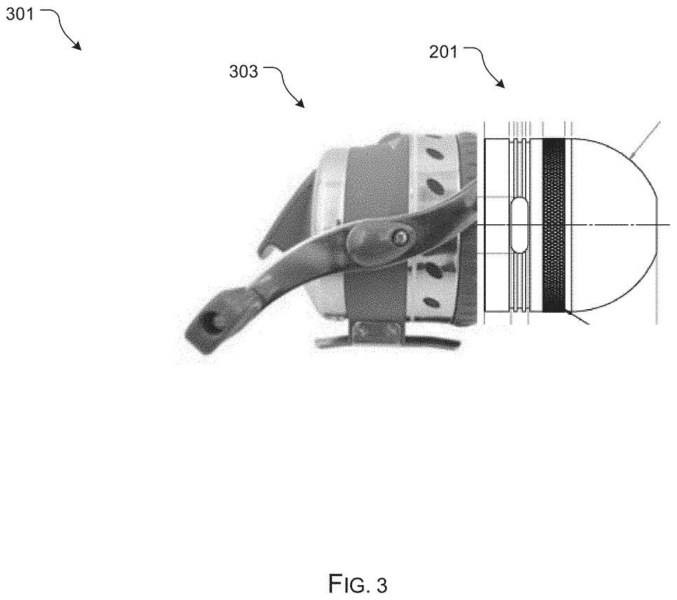

Referring now to the drawings wherein like reference characters identify corresponding or similar elements throughout the several views, HG, 2 depicts an isometric view of a cap 201 in accordance with the present application and FIG. 3 depicts a side view of a spool line release system 301 in accordance with the present application.

Cap 201 includes a body 203 that includes a first end 205 that has a first diameter 207 and a second end 209 that has a second diameter 211, the first diameter tapering to the second diameter, thereby creating a taper to the body 203. The body 203 further includes an opening 213 through which the line will extend when in use.

In some embodiments, the cap 201 further includes a slot 215 extending through a thickness of the body through which a user can apply a lubrication, for improved use of the line. Further shown, in some embodiments, a textured ring 217 will extend around a periphery of the body 203, thereby providing for grip.

It should be appreciated that one of the unique features believed characteristic of the present application is that the cap 201 is elongated when compared to the prior art. The cap 201 in the preferred embodiment being approximately 4 inches in length 219, however, slight variations can be expected. This feature, in connection with the release system discussed herein could be utilized with a bow fishing reel; however; it should be appreciated that the release system could be utilized with other spooling devices such as fishing poles and the like and should not be narrowly tailored in scope and protection to merely bow fishing reels.

As shown in FIG. 3, the cap 201 is configured to secure to a front of the reel 303, thereby replacing the conventional cap.

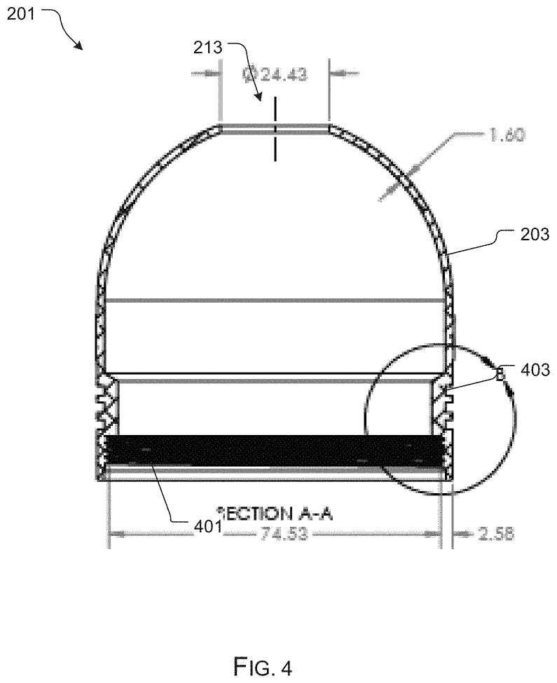

In FIG. 4, a cross sectional view of cap 201 is further shown for clarity. As shown, in the preferred embodiment, the cap 201 includes a threaded connection 401 that allows for engagement of the cap 201 with the reel. In addition, as shown, there can be included one or more notches 403 cut into the body 203.

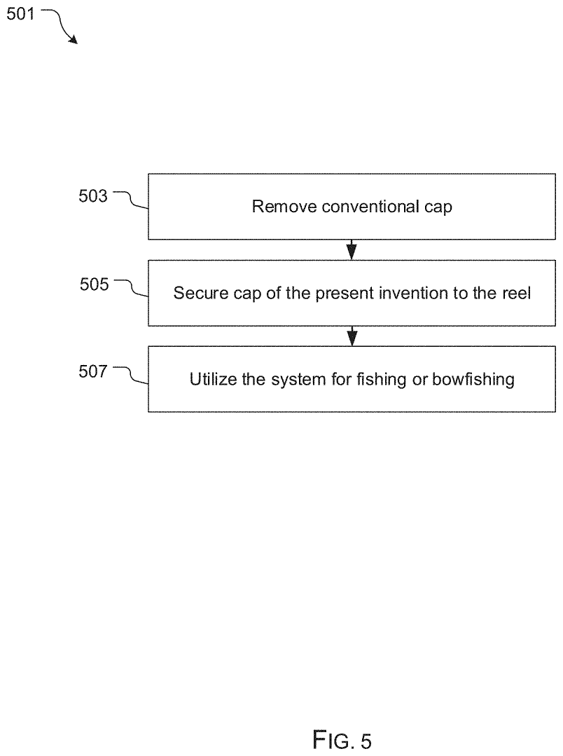

In FIG. 5, a flowchart 501 depicts a method of use of system 301. During use, the user will remove the conventional cap, as shown with box 503. From here, the user can attach cap 201 such that the line extends through the end opening, as shown with box 505. The user can then proceed to utilize the system as desired, such as for fishing or bow fishing, as shown with box 507.

The release system provides the following features, creates a greater length while releasing a line from a reel so that the angle of the line passing through the opening of the cap prevents friction, drag or other inefficiencies from affecting the line. It will be understood that as line is pulled from or released from a spool or reel that the force to cause this action slows the arrow or alters it trajectory. It is believed that that the system of the present application enables the line to flow freely from the spool thus allowing the arrow pulling the line to fly smoothly and accurately.

In one preferred embodiment, the cap of the release system could be composed of an aluminum material; however, it is contemplated that having different types of metals or other materials such as wood, plastic, composite, and the like to manufacture the cover from could be beneficial. Further, the process of manufacturing could include stamp, injection molding, 3D printing, and the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A cap for securing to a reel, the cap comprising:
a body extending from a first end to a second end;
an opening at the second end of the body and configured to have fishing line extending therethrough; and
an attachment device configured to provide for securing of the body to the reel;
wherein the cap extends away from the reel to prevent friction, drag and inefficiencies from affecting the line.

2. The cap of claim 1, further comprising:
a slot extending through a thickness of the body.

3. The cap of claim 1, further comprising:
a textured ring extending around a periphery of the body.

4. The cap of claim 1, wherein the attachment device is a threaded connection.

5. The cap of claim 1, wherein the body has a length of approximately 4 inches from the first end to the second end.

6. The cap of claim 1, wherein the body is composed of metal.

7. A spool line release system, comprising:
a reel configured to house fishing line;
a cap configured to secure to an end of the reel, the cap having:
a body extending from a first end to a second end;
an opening at the second end of the body and configured to have the fishing line extending therethrough; and
an attachment device configured to provide for securing of the body to the reel;
wherein the cap extends away from the reel to prevent friction, drag and inefficiencies from affecting the line.

8. The system of claim 7, further comprising:
a slot extending through a thickness of the body.

9. The system of claim 7, further comprising:
a textured ring extending around a periphery of the body.

10. The system of claim 7, herein the attachment device is a threaded connection.

11. The system of claim 7, wherein the body has a length of approximately 4 inches from the first end to the second end.

12. The system of claim 7, wherein the body is composed of metal.

13. A method of improving efficiency of a fishing reel, the method comprising:
providing the fishing reel;
attaching a cap to an end of the fishing reel, the cap having a body extending from a first end to a second end; an opening at the second end of the body and configured to have the fishing line extending therethrough; and an attachment device configured to provide for securing of the body to the reel; and
using the fishing reel with the cap for an activity;
wherein the cap extends away from the reel to prevent friction, drag and inefficiencies from affecting the line.
